(19) United States
(12) Patent Application Publication
(10) Pub. No.: US 2025/0373164 A1
(43) Pub. Date: Dec. 4, 2025

(54) Multiphase Power Conversion System and Method

(71) Applicant: Reed Semiconductor Corporation, Warwick, RI (US)

(72) Inventors: Wenkai Wu, East Greenwich, RI (US); Weidong Zhu, East Lyme, CT (US); Cheng-Wei Chen, East Greenwich, RI (US); Jialun Du, Powell, OH (US)

(21) Appl. No.: 19/220,056

(22) Filed: May 27, 2025

Related U.S. Application Data
(60) Provisional application No. 63/653,210, filed on May 29, 2024.

(51) Int. Cl. H02M 3/158; H02M 3/157

(52) U.S. Cl. CPC H02M 3/1586; H02M 3/157

(57) ABSTRACT

A power conversion system includes a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal, and a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage.

### PRIORITY

This application claims the benefit of U.S. Provisional Application No. 63/653,210, filed on May 29, 2024, entitled “Multiphase Power Conversion System and Method,” which application is hereby incorporated herein by reference.

### TECHNICAL FIELD

The present disclosure relates generally to the field of integrated circuits, and in particular embodiments, to techniques and mechanisms for a multiphase power conversion system.

### BACKGROUND

As technologies further advance, a variety of processors such as Digital Signal Processors (DSPs), Field Programmable Gate Arrays (FPGAs), Central Processing Units (CPUs) and/or the like, have become popular. Each processor operates with a low supply voltage (e.g., sub-1V) and consumes a large amount of current. A multiphase power conversion system is employed to power the processor. The multiphase power conversion system comprises a multiphase controller and a plurality of power stages.

The multiphase controller is an integrated circuit designed to manage and regulate power delivery in systems requiring high efficiency and stability. This type of controller is commonly used in power supplies for processors consuming a large amount of current. The multiphase controller is configured to control a plurality of power stages by generating multiple Pulse Width Modulation (PWM) signals and monitoring current sense signals. The primary objective is to distribute the load across several phases, enhancing power delivery efficiency, reducing ripple, and improving overall performance.

The core of the multiphase controller is a PWM controller. In operation, the PWM controller generates precise PWM signals for each power stage. These signals are used to control the switching of MOSFETs in each phase, regulating the voltage and current supplied to the load. The PWM signals are typically phase-shifted to interleave the switching of each power stage. This reduces the input and output ripple currents, thereby improving the overall efficiency and reducing the size of filtering components.

Each phase includes a current sense amplifier to monitor the current flowing through the inductor of this phase. The current sense signals from the plurality of power stages provide feedback to the multiphase controller for load balancing and protection. By analyzing the current sense signals, the multiphase controller ensures that each phase shares the load evenly. This prevents any single phase from becoming overloaded and enhances the longevity and reliability of the power conversion system. The output voltage is compared to a reference voltage using an error amplifier. The error signal adjusts the duty cycle of the PWM signals to maintain a stable output voltage, compensating for load changes and input voltage variations. A closed-loop feedback system is used to continuously monitor and adjust the output voltage, ensuring precise regulation.

FIG. 1 illustrates a system configuration of a multiphase controller and a plurality of smart power stages. As shown in FIG. 1, the multiphase controller 100 is connected to the plurality of smart power stages 101, 102 and 103. The multiphase controller 100 feeds a PWM signal PWM1 to a first smart power stage 101. The multiphase controller 100 feeds a PWM signal PWM2 to a second smart power stage 102. The multiphase controller 100 feeds a PWM signal PWM3 to a third smart power stage 103. As shown in FIG. 1, the number of PWM signal paths is equal to the number of the smart power stages.

As shown in FIG. 1, the multiphase controller 100 receives a current sense signal CS1 from the first smart power stage 101. The multiphase controller 100 receives a current sense signal CS2 from the second smart power stage 102. The multiphase controller 100 receives a current sense signal CS3 from the third smart power stage 103. As shown in FIG. 1, the number of current sense signal paths is equal to the number of the smart power stages.

FIG. 1 shows that for a multiphase power conversion system having N smart power stages, the number of PWM signal paths is equal to N. The number of current sense signal paths is equal to N. In total, there are 2×N signal paths in FIG. 1.

FIG. 2 illustrates another system configuration of a multiphase controller and a plurality of smart power stages. The system configuration shown in FIG. 2 is similar to that shown in FIG. 1 except that two smart power stages (e.g., smart power stages 111 and 112, smart power stages 121 and 122, and smart power stages 131 and 132) are packaged in a dual smart power stage. In this system configuration, the multiphase controller 200 generates PWM signals fed into the smart power stages, and receives current sense signals sent from the smart power stages. As shown in FIG. 2, the number of PWM signal paths is equal to the number of the smart power stages. Likewise, the number of current sense signal paths is equal to the number of the smart power stages.

FIG. 2 shows for a multiphase power conversion system having N smart power stages, the number of PWM signal paths is equal to N. The number of current sense signal paths is equal to N. In total, there are 2×N signal paths in FIG. 2.

The multiphase controllers shown in FIGS. 1-2 act as the central control units that coordinate the operation of all smart power stages. Each multiphase controller generates PWM signals, which are essential for controlling the output voltage and current of each smart power stage. The PWM signals are precisely timed and modulated to manage power delivery efficiently. The multiphase controllers receive current sense signals from smart power stages. These current sense signals provide feedback about the current being delivered by each phase, allowing the multiphase controllers to monitor and adjust the operation of the smart power stages.

Each smart power stage represents an individual phase of the multiphase power conversion system. They are independently controlled by the PWM signals sent from the multiphase controller. Each smart power stage includes current sensing mechanisms to measure the current flowing through it. The sensed current data is then sent back to the multiphase controller. The current sense signals form a feedback loop that the multiphase controller uses to adjust the PWM signals dynamically, ensuring power delivery and load balancing across all phases.

In operation, the multiphase controller calculates the required PWM signals based on the desired output and the feedback received from the smart power stages. It sends out these PWM signals to each smart power stage, controlling their operation in a synchronized manner. Each smart power stage senses the current flowing through it and sends this data back to the multiphase controller. The multiphase controller processes this current sense information to determine the load distribution and current levels in each phase. Based on the feedback, the multiphase controller dynamically adjusts the PWM signals fed into each power stage. This adjustment helps in balancing the load, preventing any single phase from becoming overloaded, and maintaining the overall efficiency and stability of the multiphase power conversion system.

In a multiphase power conversion system, managing numerous signal paths efficiently is crucial to minimize layout issues and ensure better performance. It would be desirable to reduce the total number of signal paths. The present disclosure addresses this need.

### SUMMARY

Technical advantages are generally achieved, by embodiments of this disclosure which describe a multiphase power conversion system.

In accordance with an embodiment, a power conversion system comprises a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal, and a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage.

In accordance with another embodiment, a method comprises combining two PWM signals of a plurality of PWM signals into a mixed PWM signal fed into a dual power stage comprising a first power stage and a second power stage, splitting the mixed PWM signal into a first PWM signal fed into the first power stage and a second PWM signal fed into the second power stage, generating a first current sense signal and a second current sense signal, wherein the first current sense signal is proportional to a current flowing through a first inductor coupled to the first power stage and the second current sense signal is proportional to a current flowing through a second inductor coupled to the second power stage, and summing the first current sense signal and the second current sense signal together to obtain a mixed current sense signal fed into a PWM generator configured to generate the plurality of PWM signals.

In accordance with yet another embodiment, a system comprises a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal, a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage, a first inductor coupled between the first power stage and an output of the system, and a second inductor coupled between the second power stage and the output of the system.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a system configuration of a multiphase controller and a plurality of smart power stages;

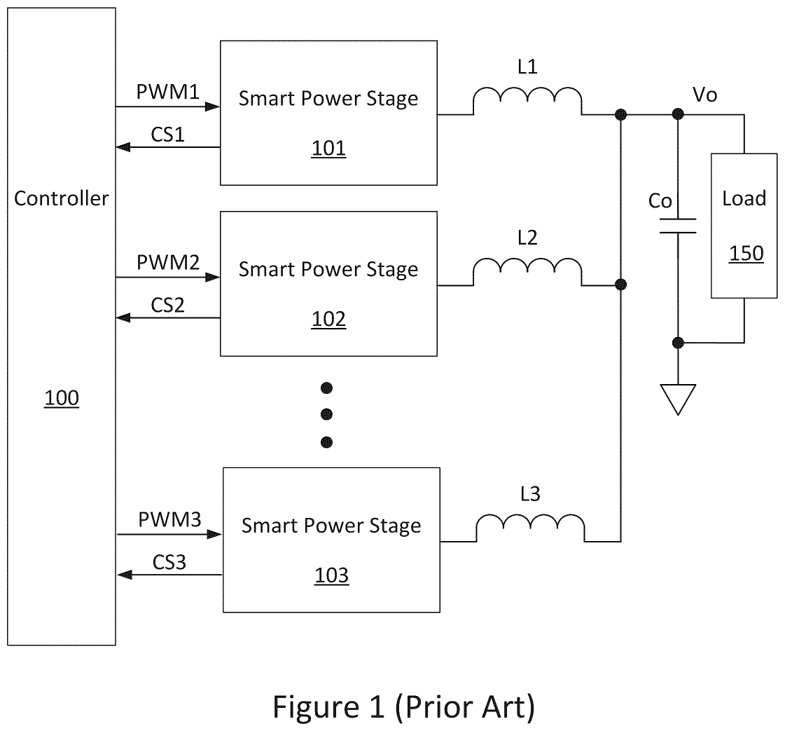

FIG. 2 illustrates another system configuration of a multiphase controller and a plurality of smart power stages;

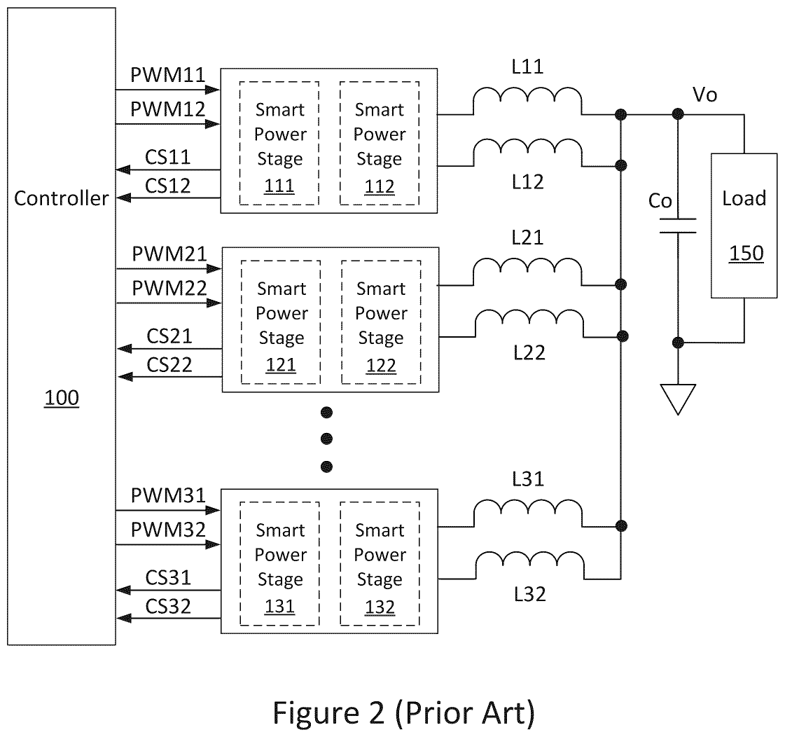

FIG. 3 illustrates a block diagram of a first implementation of a multiphase power conversion system having a reduced number of signal paths in accordance with various embodiments of the present disclosure;

FIG. 4 illustrates a block diagram of the multiphase controller shown in FIG. 3 in accordance with various embodiments of the present disclosure;

FIG. 5 illustrates a schematic diagram of the signal summing module shown in FIG. 4 in accordance with various embodiments of the present disclosure;

FIG. 6 illustrates a schematic diagram of the phase splitter shown in FIG. 3 in accordance with various embodiments of the present disclosure;

FIG. 7 illustrates various control signals associated with the phase splitter shown in FIG. 6 in accordance with various embodiments of the present disclosure;

FIG. 8 illustrates a schematic diagram of a first implementation of the dual power stage shown in FIG. 3 in accordance with various embodiments of the present disclosure;

FIG. 9 illustrates a schematic diagram of the first current sense apparatus shown in FIG. 8 in accordance with various embodiments of the present disclosure;

FIG. 10 illustrates a schematic diagram of the low side current sense unit shown in FIG. 9 in accordance with various embodiments of the present disclosure;

FIG. 11 illustrates a schematic diagram of the second current sense apparatus shown in FIG. 8 in accordance with various embodiments of the present disclosure;

FIG. 12 illustrates a schematic diagram of a second implementation of the dual power stage shown in FIG. 3 in accordance with various embodiments of the present disclosure;

FIG. 13 illustrates a block diagram of a second implementation of the multiphase power conversion system having a reduced number of signal paths in accordance with various embodiments of the present disclosure; and

FIG. 14 illustrates a flow chart of a method for configuring the power conversion system shown in FIG. 3 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a multiphase power conversion system. The disclosure may also be applied, however, to a variety of power conversion systems. Hereinafter, various embodiments will be explained in detail with reference to the accompanying drawings.

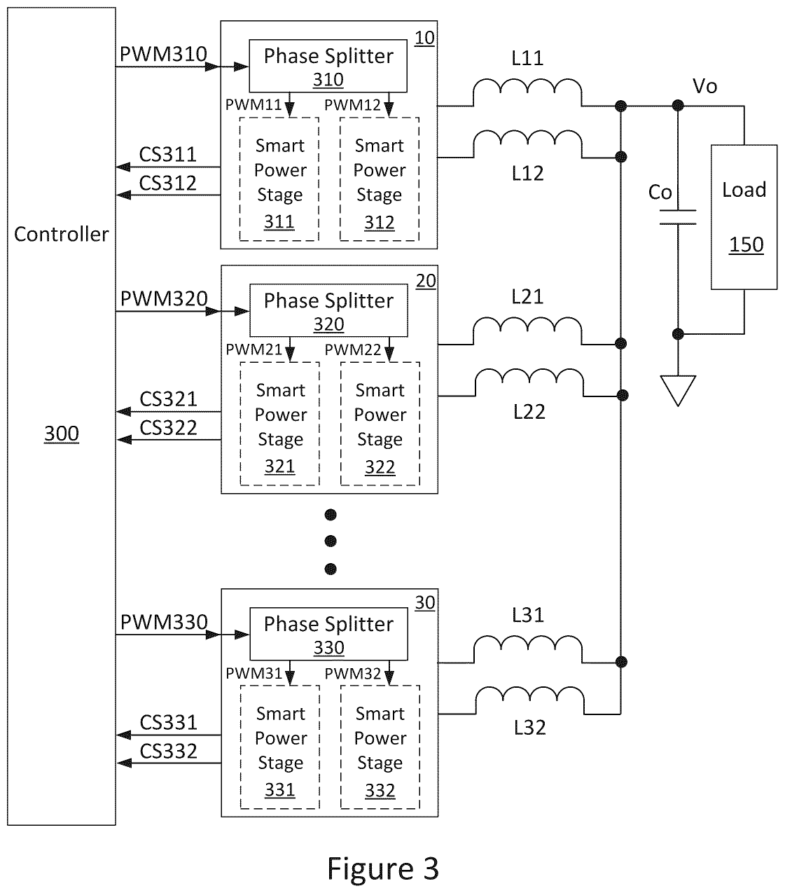

FIG. 3 illustrates a block diagram of a first implementation of a multiphase power conversion system having a reduced number of signal paths in accordance with various embodiments of the present disclosure. The multiphase power conversion system comprises a multiphase controller 300 and a plurality of dual smart power stages. Each dual smart power stage comprises two smart power stages. The smart power stage is implemented as a buck converter.

The multiphase controller 300 comprises a PWM generator and a plurality of signal summing modules. The PWM generator 310 is configured to generate a plurality of PWM signals. Each signal summing module is configured to receive two PWM signals and combine the two PWM signals into a mixed PWM signal (e.g., PWM310, PWM320 and PWM330).

As shown in FIG. 3, each dual smart power stage comprises a phase splitter and two smart power stages. A first dual smart power stage 10 comprises a first phase splitter 310 and smart power stages 311 and 312. The smart power stage 311 is alternatively referred to as a first power stage of the first dual smart power stage 10. The smart power stage 312 is alternatively referred to as a second power stage of the first dual smart power stage 10. The second dual smart power stage 20 comprises a second phase splitter 320 and smart power stages 321 and 322. The smart power stage 321 is alternatively referred to as a first power stage of the second dual smart power stage 20. The smart power stage 322 is alternatively referred to as a second power stage of the second dual smart power stage 20. The third dual smart power stage 30 comprises a third phase splitter 330 and smart power stages 331 and 332. The smart power stage 331 is alternatively referred to as a first power stage of the third dual smart power stage 30. The smart power stage 332 is alternatively referred to as a second power stage of the third dual smart power stage 30.

In operation, the first phase splitter 310 of the first dual smart power stage 10 is configured to receive the mixed PWM signal PWM310, and split the mixed PWM signal PWM310 into a first PWM signal PWM11 fed into the smart power stage 311 and a second PWM signal PWM12 fed into the smart power stage 312. The second phase splitter 320 of the second dual smart power stage 20 is configured to receive the mixed PWM signal PWM320, and split the mixed PWM signal PWM320 into a first PWM signal PWM21 fed into the smart power stage 321 and a second PWM signal PWM22 fed into the smart power stage 322. The third phase splitter 330 of the third dual smart power stage 30 is configured to receive the mixed PWM signal, PWM330, and split the mixed PWM signal PWM330 into a first PWM signal PWM31 fed into the smart power stage 331 and a second PWM signal PWM32 fed into the smart power stage 332.

As shown in FIG. 3, the smart power stage 311 is configured to generate a first current sense signal CS311 of the first dual smart power stage 10 fed into the multiphase controller 300. The first current sense signal CS311 is proportional to a current flowing through an inductor L11 coupled to the smart power stage 311. The smart power stage 312 is configured to generate a second current sense signal CS312 of the first dual smart power stage 10 fed into the multiphase controller 300. The second current sense signal CS312 is proportional to a current flowing through an inductor L12 coupled to the smart power stage 312.

As shown in FIG. 3, the smart power stage 321 is configured to generate a first current sense signal CS321 of the second dual smart power stage 20 fed into the multiphase controller 300. The first current sense signal CS321 is proportional to a current flowing through an inductor L21 coupled to the smart power stage 321. The smart power stage 322 is configured to generate a second current sense signal CS322 of the second dual smart power stage 20 fed into the multiphase controller 300. The second current sense signal CS322 is proportional to a current flowing through an inductor L22 coupled to the smart power stage 322.

As shown in FIG. 3, the smart power stage 331 is configured to generate a first current sense signal CS331 of the third dual smart power stage 30 fed into the multiphase controller 300. The first current sense signal CS331 is proportional to a current flowing through an inductor L31 coupled to the smart power stage 331. The smart power stage 332 is configured to generate a second current sense signal CS332 of the third dual smart power stage 30 fed into the multiphase controller 300. The second current sense signal CS332 is proportional to a current flowing through an inductor L32 coupled to the smart power stage 332.

As shown in FIG. 3, the number of PWM signal paths between the multiphase controller 300 and the dual smart power stages is equal to the number of the dual smart power stages. The number of current sense signal paths between the multiphase controller 300 and the dual smart power stages is equal to the number of the smart power stages. FIG. 3 shows for a multiphase power conversion system having N smart power stages, the number of PWM signal paths is equal to N/2. The number of current sense signal paths is equal to N. In total, there are 1.5×N signal paths in FIG. 3.

One advantageous feature of the system configuration shown in FIG. 3 is that the total number of signal paths has been reduced from 2×N to 1.5×N. The reduced number of signal paths helps to minimize layout issues and ensures better performance.

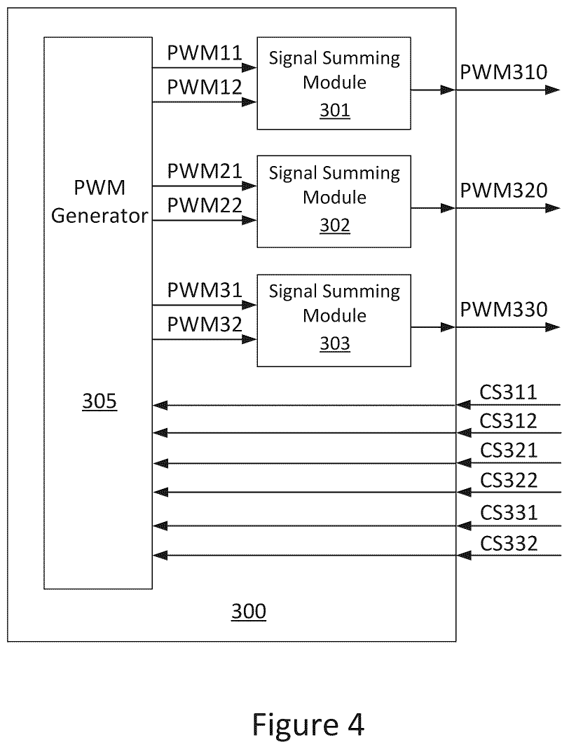

FIG. 4 illustrates a block diagram of the multiphase controller shown in FIG. 3 in accordance with various embodiments of the present disclosure. The multiphase controller 300 comprises a PWM generator 305 and a plurality of signal summing modules 301, 302 and 303. The PWM generator 305 is configured to generate a plurality of PWM signals. As shown in FIG. 4, each signal summing module is configured to receive two PWM signals and combine the two PWM signals into a mixed PWM signal. More particularly, a first signal summing module 301 receives PWM signals PWM11 and PWM12, and combine these two PWM signals into a mixed PWM signal PWM310 comprising PWM11 and PWM12. In some embodiments, a phase shift between PWM11 and PWM12 is equal to 180 degrees. Likewise, a second signal summing module 302 receives PWM signals PWM21 and PWM22, and combine these two PWM signals into a mixed PWM signal PWM320 comprising PWM21 and PWM22. In some embodiments, a phase shift between PWM21 and PWM22 is equal to 180 degrees. A third signal summing module 303 receives PWM signals PWM31 and PWM32, and combine these two PWM signals into a mixed PWM signal PWM330 comprising PWM31 and PWM32. In some embodiments, a phase shift between PWM31 and PWM32 is equal to 180 degrees.

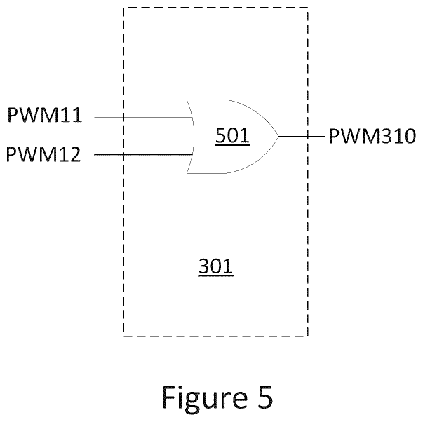

FIG. 5 illustrates a schematic diagram of the signal summing module shown in FIG. 4 in accordance with various embodiments of the present disclosure. The signal summing module 301 comprises an OR gate 501. As shown in FIG. 5, a first input of the OR gate 501 is configured to receive the PWM signal PWM11. A second input of the OR gate 501 is configured to receive the PWM signal PWM12. Because PWM11 and PWM12 are phase-shifted by 180 degrees, the OR gate 501 effectively combines them into a mixed PWM signal, PWM310, in which PWM11 and PWM12 are interleaved with a 180-degree phase difference.

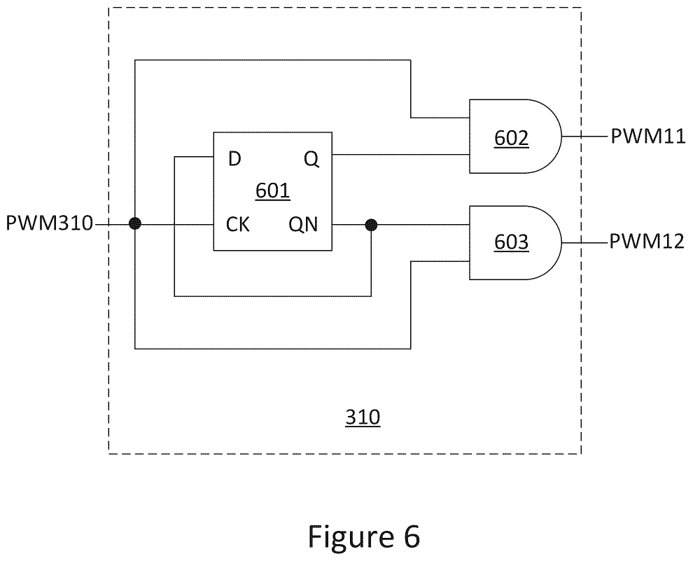

FIG. 6 illustrates a schematic diagram of the phase splitter shown in FIG. 3 in accordance with various embodiments of the present disclosure. The phase splitter 310 comprises a latch 601, a first AND gate 602 and a second AND gate 603. As shown in FIG. 6, a data input of the latch 601 is connected to an inverted output of the latch 601. A clock input of the latch 601 is configured to receive the mixed PWM signal PWM310. A first input of the first AND gate 602 is configured to receive the mixed PWM signal PWM310. A second input of the first AND gate 602 is connected to the output of the latch 601. An output of the first AND gate 602 is configured to generate the first PWM signal PWM11. A first input of the second AND gate 602 is connected to the inverted output of the latch 601. A second input of the second AND gate 603 is configured to receive the mixed PWM signal PWM310. An output of the second AND gate 603 is configured to generate the second PWM signal PWM12. In operation, the phase splitter 310 extracts the PWM signals PWM11 and PWM12 based upon the received mixed PWM signal PWM310.

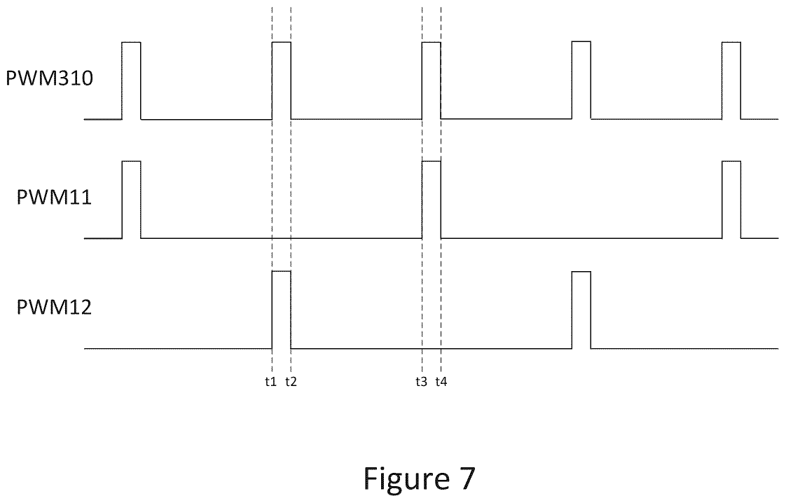

FIG. 7 illustrates various control signals associated with the phase splitter shown in FIG. 6 in accordance with various embodiments of the present disclosure. The horizontal axis of FIG. 7 represents intervals of time. There are three rows in FIG. 7. The first row represents the mixed PWM signal PWM310. The second row represents the first PWM signal PWM11. The third row represents the second PWM signal PWM12.

At t1, in response to the leading edge of the mixed PWM signal PWM310, the first PWM signal PWM11 remains the same. The second PWM signal PWM12 changes from a logic low state to a logic high state. At t2, in response to the falling edge of the mixed PWM signal PWM310, the first PWM signal PWM11 remains the same. The second PWM signal PWM12 changes from a logic high state to a logic low state.

At t3, in response to the leading edge of the mixed PWM signal PWM310, the second PWM signal PWM12 remains the same. The first PWM signal PWM11 changes from a logic low state to a logic high state. At t4, in response to the falling edge of the mixed PWM signal PWM310, the second PWM signal PWM12 remains the same. The first PWM signal PWM11 changes from a logic high state to a logic low state.

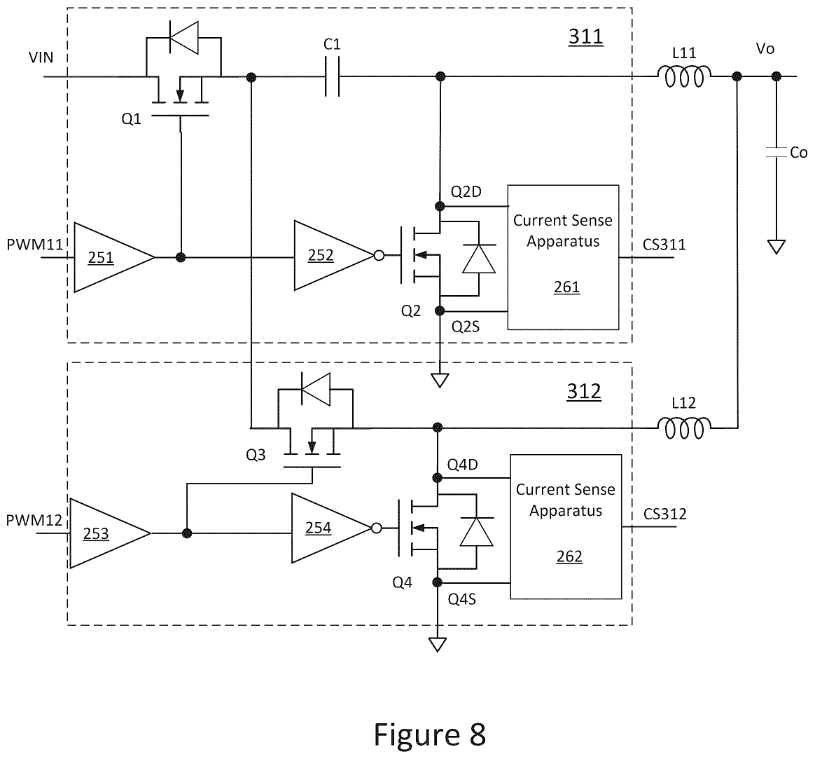

FIG. 8 illustrates a schematic diagram of a first implementation of the dual power stage shown in FIG. 3 in accordance with various embodiments of the present disclosure. The dual power stage comprises a first power stage 311 and a second power stage 312. As shown in FIG. 8, the first power stage 311 and the first inductor L11 form a first phase of the multiphase power conversion system. The second power stage 312 and the second inductor L12 form a second phase of the multiphase power conversion system. In operation, the first phase and the second phase are connected in parallel to supply power for a load coupled to the output voltage bus Vo of the multiphase power conversion system.

As shown in FIG. 8, the first phase of the multiphase power conversion system comprises a high-side switch Q1, a low-side switch Q2, a capacitor C1 and the first inductor L11. The high-side switch Q1 of the first phase, the capacitor C1 and the first inductor L11 are connected in series between an input voltage bus VIN and the output voltage bus Vo. The low-side switch Q2 of the first phase is connected between a common node of the capacitor C1 and the first inductor L11, and ground.

The second phase of the multiphase power conversion system comprises a high-side switch Q3, a low-side switch Q4 and the second inductor L12. The high-side switch Q3 of the second phase and the second inductor L12 are connected in series between a common node of the high-side switch Q1 of the first phase and the capacitor C1, and the output voltage bus Vo. The low-side switch Q4 of the second phase is connected between a common node of the high-side switch Q3 of the second phase and the second inductor L12, and ground. An output capacitor Co is connected between the output voltage bus Vo and ground. A load (not shown) is connected in parallel with the output capacitor Co.

In accordance with an embodiment, the switches (e.g., switches Q1-Q4) may be metal oxide semiconductor field-effect transistor (MOSFET) devices. Alternatively, the switches can be any controllable switches such as insulated gate bipolar transistor (IGBT) devices, integrated gate commutated thyristor (IGCT) devices, gate turn-off thyristor (GTO) devices, silicon-controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted while FIG. 8 shows that the switches Q1 and Q3 are implemented as single n-type transistors, a person skilled in the art would recognize there may be many variations, modifications and alternatives. For example, depending on different applications and design needs, the switches Q1 and Q3 may be implemented as p-type transistors. Furthermore, each switch shown in FIG. 8 may be implemented as a plurality of switches connected in parallel.

The multiphase power conversion system further comprises a first high-side driver 251, a second high-side driver 253, a first inverter 252 and a second inverter 254. In some embodiments, the first inverter 252 functions as a first low-side driver. The second inverter 254 functions as a second low-side driver.

The first high-side driver 251 is configured to receive the first PWM signal PWM11. Based on the received signal, the first high-side driver 251 generates a high-side gate drive signal applied to the gate of the high-side switch Q1. Furthermore, the first PWM signal PWM11 passes through the first inverter 252. Based on the received signal, the first inverter 252 generates a low-side gate drive signal applied to the gate of the low-side switch Q2.

The second high-side driver 253 is configured to receive the second PWM signal PWM12. Based on the received signal, the second high-side driver 253 generates a high-side gate drive signal applied to the gate of the high-side switch Q3. Furthermore, the second PWM signal PWM12 passes through the second inverter 254. Based on the received signal, the second inverter 254 generates a low-side gate drive signal applied to the gate of the low-side switch Q4.

The driver circuit shown in FIG. 8 is a simplified representation provided to illustrate the innovative aspects of the present disclosure. It should be understood that in practical implementations, the driver circuit may include additional functional blocks such as a dead time control circuit or other necessary circuitry to ensure proper operation.

The multiphase power conversion system further comprises a first current sense apparatus 261 and a second current sense apparatus 262. As shown in FIG. 8, a first input of the first current sense apparatus 261 is connected to a drain Q2D of the low-side switch Q2. A second input of the first current sense apparatus 261 is connected to a source Q2S of the low-side switch Q2. The first current sense apparatus 261 is configured to sense the current flowing through the first inductor L11. As shown in FIG. 8, the first current sense apparatus 261 is configured to generate a first current sense signal CS311.

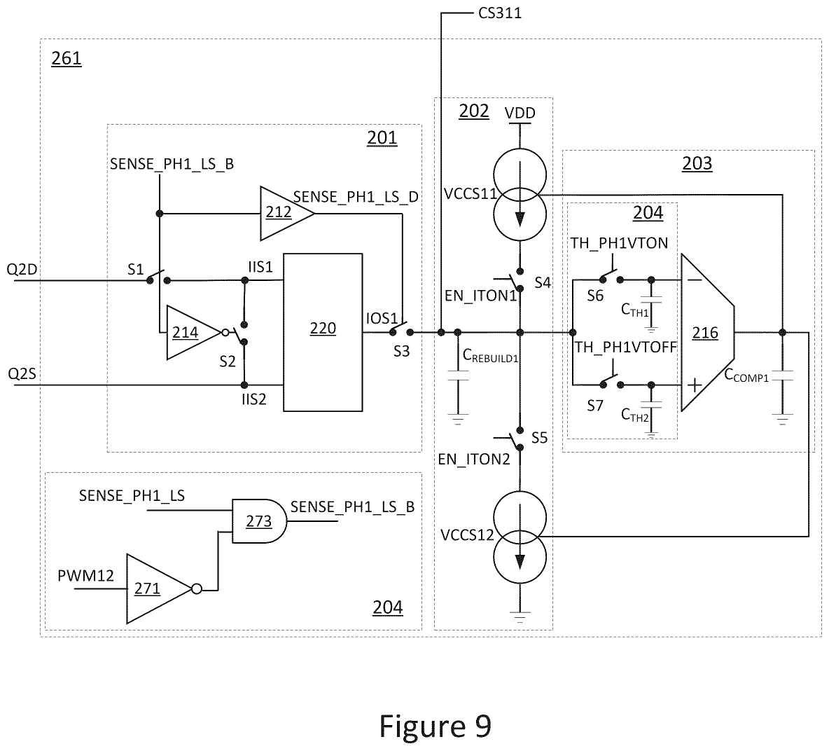

In some embodiments, the first current sense apparatus 261 comprises a first phase PWM off time current sense circuit, a first phase PWM on and off time current rebuild circuit and a first phase feedback loop. The detailed structure and operating principle of the first current sense apparatus 261 will be described below with respect to FIG. 9.

As shown in FIG. 8, a first input of the second current sense apparatus 262 is connected to a drain Q4D of the low-side switch Q4. A second input of the second current sense apparatus 262 is connected to a source Q4S of the low-side switch Q4. The second current sense apparatus 262 is configured to sense the current flowing through the second inductor L12. As shown in FIG. 8, the second current sense apparatus 262 is configured to generate a second current sense signal CS312.

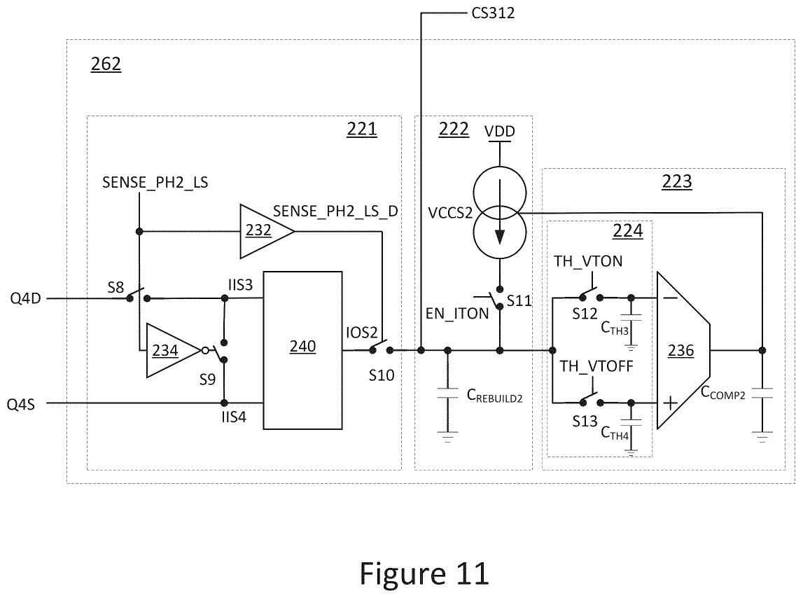

In some embodiments, the second current sense apparatus 262 comprises a second phase PWM off time current sense circuit, a second phase PWM on time current rebuild circuit and a second phase feedback loop. The detailed structure and operating principle of the second current sense apparatus 262 will be described below with respect to FIG. 11.

In operation, the first phase PWM off time current sense circuit is configured to generate a first portion and a third portion of a first phase PWM off time current signal proportional to the current flowing through the first inductor L11 when the high-side switch Q1 is turned off, the high-side switch Q3 is turned off, and the low-side switch Q2 is turned on.

In operation, the first phase PWM on and off time current rebuild circuit is configured to construct a second portion of the first phase PWM off time current signal using a second voltage-controlled current source to discharge a first rebuild capacitor when the high-side switch Q3 of the second phase is turned on. Furthermore, the first phase PWM on and off time current rebuild circuit is configured to construct an artificial first phase inductor current signal using a first voltage-controlled current source to charge the first rebuild capacitor when a high-side switch Q1 of the first phase is turned on.

In operation, the first phase feedback loop is configured to adjust the current flowing through the second voltage-controlled current source so as to force a saved voltage of the second portion of the first phase PWM off time current signal to be equal to a saved voltage of the third portion of the first phase PWM off time current signal. Furthermore, the first phase feedback loop is configured to adjust a current flowing through the first voltage-controlled current source so as to force a saved voltage of the artificial first phase inductor current signal to be equal to a saved voltage of the first portion of the first phase PWM off time current signal.

In operation, the second phase PWM off time current sense circuit is configured to generate a second phase PWM off time current signal proportional to a current flowing through the second inductor L12 when the high-side switch Q3 of the second phase is turned off and the low-side switch Q4 of the second phase is turned on.

In operation, the second phase PWM on time current rebuild circuit is configured to construct an artificial second phase inductor current signal using a second phase voltage-controlled current source to charge a second rebuild capacitor when the high-side switch Q3 of the second phase is turned on.

In operation, the second phase feedback loop is configured to adjust a current flowing through the second phase voltage-controlled current source so as to force a saved voltage of the artificial second phase inductor current signal to be equal to a saved voltage of the second phase PWM off time current signal.

FIG. 9 illustrates a schematic diagram of the first current sense apparatus shown in FIG. 8 in accordance with various embodiments of the present disclosure. The first current sense apparatus 261 comprises a first phase PWM off time current sense circuit 201, a first phase PWM on and off time current rebuild circuit 202, a first phase feedback loop 203 and a blanking circuit 204 as shown in FIG. 9.

The blanking circuit 204 comprises an AND gate 273 and a blanking inverter 271. The input of the blanking inverter 271 is configured to receive PWM12. The first input of the AND gate 273 is configured to receive a low-side current sense control signal SENSE_PH1_LS. The second input of the AND gate 273 is coupled to the output of the blanking inverter 271. The output of the AND gate 273 is configured to generate a blanked low-side current sense control signal SENSE_PH1_LS_B.

The first phase PWM off time current sense circuit 201 comprises a low-side switch current sense unit 220, a first switch S1, a second switch S2, a third switch S3, an inverter 214 and a delay unit 212. As shown in FIG. 9, the low-side switch current sense unit 220 has a first input IIS1 coupled to Q2D through the first switch S1, a second input IIS2 connected to ground, and an output IOS1 configured to generate a first phase PWM off time current signal.

As shown in FIG. 9, the third switch S3 is connected to the output of the low-side switch current sense unit 220. The blanked low-side current sense control signal SENSE_PH1_LS_B is configured to control the first switch S1 directly, and control the second switch S2 through the inverter 214. The blanked low-side current sense control signal SENSE_PH1_LS_B is also configured to control the third switch S3 through the delay unit 212. The delay unit 212 is configured to add a predetermined delay into the blanked low-side current sense control signal SENSE_PH1_LS_B. The delay unit 212 generates a delayed rising edge signal SENSE_PH1_LS_D. In other words, there is a predetermined delay between the rising edge of SENSE_PH1_LS_B and the rising edge of SENSE_PH1_LS_D. As shown in FIG. 9, the first phase PWM off time current signal generated by the low-side switch current sense unit 220 is fed into a first rebuild capacitor C_{REBUILD1} through the third switch S3.

In operation, the first phase PWM off time current sense circuit 201 is configured to generate the first phase PWM off time current signal, which is proportional to a current flowing through the first inductor L11 when the high-side switch Q1 of the first phase is turned off, the high-side switch Q3 of the second phase is turned off, and the low-side switch Q2 of the first phase is turned on.

The first phase PWM on and off time current rebuild circuit 202 comprises a first voltage-controlled current source VCCS11, a second voltage-controlled current source VCCS12, the first rebuild capacitor C_{REBUILD1}, a fourth switch S4 and a fifth switch S5. As shown in FIG. 9, the first voltage-controlled current source VCCS11, the fourth switch S4, the fifth switch S5 and the second voltage-controlled current source VCCS12 are connected in series between a bias voltage source VDD and ground. The first rebuild capacitor C_{REBUILD1} is connected between a common node of S4 and S5, and ground. The fourth switch S4 is controlled by a first enable signal EN_ITON1. The first enable signal EN_ITON1 is configured such that the fourth switch S4 is turned on when the high-side switch Q1 is turned on. The fifth switch S5 is controlled by a second enable signal EN_ITON2. The second enable signal EN_ITON2 is configured such that the fifth switch S5 is turned on when the high-side switch Q3 is turned on.

In operation, the first phase PWM on and off time current rebuild circuit 202 is configured to construct an artificial inductor current signal using the first voltage-controlled current source VCCS11 to charge the first rebuild capacitor C_{REBUILD1} when the high-side switch Q1 of the first phase is turned on. Furthermore, the first phase PWM on and off time current rebuild circuit 202 is configured to construct the second portion of the first phase PWM off time current signal using the second voltage-controlled current source VCCS12 to discharge the first rebuild capacitor C_{REBUILD1} when the high-side switch Q3 of the second phase is turned on.

The first phase feedback loop 203 comprises a track-and-hold circuit 204, a transconductance amplifier 216 and a first compensation capacitor C_{COMP1}. An input of the track-and-hold circuit 204 is connected to both the first phase PWM off time current sense circuit 201 and the first phase PWM on and off time current rebuild circuit 202. Two inputs of the transconductance amplifier 216 are connected to two outputs of the track-and-hold circuit 204, respectively. The first compensation capacitor C_{COMP1} is connected to an output of the transconductance amplifier 216.

As shown in FIG. 9, the track-and-hold circuit 204 comprises a sixth switch S6, a first hold capacitor C_{TH1}, a seventh switch S7 and a second hold capacitor C_{TH2}. The sixth switch S6 and the first hold capacitor C_{TH1} are connected in series between the input of the track-and-hold circuit 204 and ground. A common node of the sixth switch S6 and the first hold capacitor C_{TH1} is connected to a first input of the transconductance amplifier 216. The seventh switch S7 and the second hold capacitor C_{TH2} are connected in series between the input of the track-and-hold circuit 204 and ground. A common node of the seventh switch S7 and the second hold capacitor C_{TH2} is connected to a second input of the transconductance amplifier 216.

The first phase feedback loop 203 is capable of constructing the current sense signal through adjusting the current generated by the first voltage-controlled current source VCCS11.

In operation, the sixth switch S6 is controlled by a first control signal TH_PHIVTON. The first control signal TH_PHIVTON is configured such that a saved voltage of the artificial first phase inductor current signal is held on the first hold capacitor C_{TH1}. The saved voltage of the artificial first phase inductor current signal is approximately equal to the voltage of the current sense signal at the time instant at which Q1 is turned off. The seventh switch S7 is controlled by a second control signal TH_PHIVTOFF. The second control signal TH_PHIVTOFF is configured such that a saved voltage of the first portion of the first phase PWM off time current signal is held on the second hold capacitor C_{TH2}. The saved voltage of the first portion of the first phase PWM off time current signal is approximately equal to the voltage of the first portion of the first phase PWM off time current signal at the time instant at which Q2 is turned on.

In operation, the first phase feedback loop 203 is configured to adjust a current flowing through the first voltage-controlled current source VCCS11 so as to make the saved voltage of the artificial first phase inductor current signal equal to the saved voltage of the first portion of the first phase PWM off time current signal. Once the saved voltage of the artificial first phase inductor current signal is equal to the saved voltage of the first portion of the first phase PWM off time current signal, the artificial first phase inductor current signal is of a shape similar to that of the current flowing through the high-side switch Q1.

The first phase feedback loop 203 is also capable of constructing the waveform of the current sense signal in the time period in which Q3 is turned on through adjusting the current generated by the second voltage-controlled current source VCCS12.

In operation, the second control signal TH_PHIVTOFF is configured such that a saved voltage of the second portion of the first phase PWM off time current signal is held on the second hold capacitor C_{TH2}. The saved voltage of the second portion of the first phase PWM off time current signal is approximately equal to the voltage of the current sense signal at a time instant at which Q3 is turned off and Q4 is turned on. The first control signal TH_PHIVTON is configured such that a saved voltage of the third portion of the first phase PWM off time current signal is held on the first hold capacitor C_{TH1}. The saved voltage of the third portion of the first phase PWM off time current signal is approximately equal to the voltage of the third portion of the first phase PWM off time current signal at a time instant at which Q3 is turned off and Q4 is turned on.

In operation, the first phase feedback loop 203 is configured to adjust a current flowing through the second voltage-controlled current source VCCS12 so as to make the saved voltage of the second portion of the first phase PWM off time current signal equal to the saved voltage of the third portion of the first phase PWM off time current signal. Once the saved voltage of the second portion of the first phase PWM off time current signal is equal to the saved voltage of the third portion of the first phase PWM off time current signal, the second portion of the first phase PWM off time current signal has a shape similar to the current flowing through the first inductor L11.

It should be noted that the single-ended current sense apparatus shown in FIG. 9 can be designed in a fully-differential form. More particularly, the low-side switch current sense unit 220 can be implemented as a fully-differential amplifier. The two outputs of the fully-differential amplifier are fed into two rebuild capacitors, two voltage-controlled current sources, two track-and-hold circuits and two transconductance amplifiers. In other words, there are two closely related symmetrical PWM on time current rebuild circuits in a current sense apparatus designed in a fully-differential form.

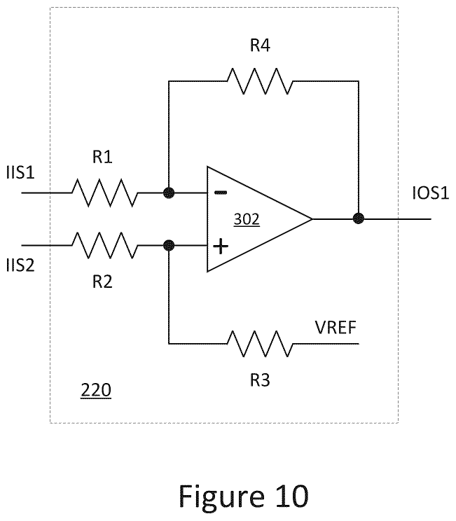

FIG. 10 illustrates a schematic diagram of the low side current sense unit shown in FIG. 9 in accordance with various embodiments of the present disclosure. In some embodiments, the low-side switch current sense unit 220 is implemented as a differential to single-ended amplifier. As shown in FIG. 10, the differential to single-ended amplifier comprises an amplifier 302, a first resistor R1, a second resistor R2, a third resistor R3 and a fourth resistor R4.

The first resistor R1 is connected between the first input IIS1 and an inverting input of the amplifier 302. The second resistor R2 is connected between the second input IIS2 and a non-inverting input of the amplifier 302. The third resistor R3 is connected between the non-inverting input of the amplifier 302 and a predetermined reference VREF. The fourth resistor R4 is connected between the inverting input of the amplifier 302 and the output IOS1 of the amplifier 302.

FIG. 11 illustrates a schematic diagram of the second current sense apparatus shown in FIG. 8 in accordance with various embodiments of the present disclosure. The second current sense apparatus 262 comprises a second phase PWM off time current sense circuit 221, a second phase PWM on time current rebuild circuit 222 and a second phase feedback loop 223 as shown in FIG. 11.

The second phase PWM off time current sense circuit 221 comprises a low-side switch current sense unit 240, an eighth switch S8, a ninth switch S9, a tenth switch S10, an inverter 234 and a delay unit 232. The low-side current sense control signal SENSE_PH2_LS is configured to control the eighth switch S8 directly, and control the ninth switch S9 through the inverter 234. The low-side current sense control signal SENSE_PH2_LS is also configured to control the tenth switch S10 through the delay unit 232. The operating principle of the second phase PWM off time current sense circuit 221 is similar to that of the first phase PWM off time current sense circuit 201 shown in FIG. 9, and hence is not discussed herein to avoid repetition.

The second phase PWM on time current rebuild circuit 222 comprises a second phase voltage-controlled current source VCCS2, a second rebuild capacitor C_{REBUILD2} and an eleventh switch S11. As shown in FIG. 11, the second phase voltage-controlled current source VCCS2, the eleventh switch S11 and the second rebuild capacitor C_{REBUILD2} are connected in series between the bias voltage source VDD and ground. The eleventh switch S11 is controlled by an enable signal EN_ITON. The operating principle of the second phase PWM on time current rebuild circuit 222 is similar to that of the first phase PWM on and off time current rebuild circuit 202 shown in FIG. 9, and hence is not discussed herein to avoid repetition.

The second phase feedback loop 223 comprises a track-and-hold circuit 224, a transconductance amplifier 236 and a second compensation capacitor C_{COMP2}. The track-and-hold circuit 224 comprises a twelfth switch S12, a third hold capacitor C_{TH3}, a thirteenth switch S13 and a fourth hold capacitor C_{TH4}. The operating principle of the second phase feedback loop 223 is similar to that of the first phase feedback loop 203 shown in FIG. 9, and hence is not discussed herein to avoid repetition.

In some embodiments, the second phase PWM off time current sense circuit 221, the second phase PWM on time current rebuild circuit 222 and the second phase feedback loop 223 are configured to generate a second current sense signal CS312. The second current sense signal CS312 includes two portions. A first portion is formed by sensing a current flowing through the low-side switch Q4 when the low-side switch Q4 is turned on. A second portion is generated based on the artificial second phase inductor current signal when the high-side switch Q3 is turned on.

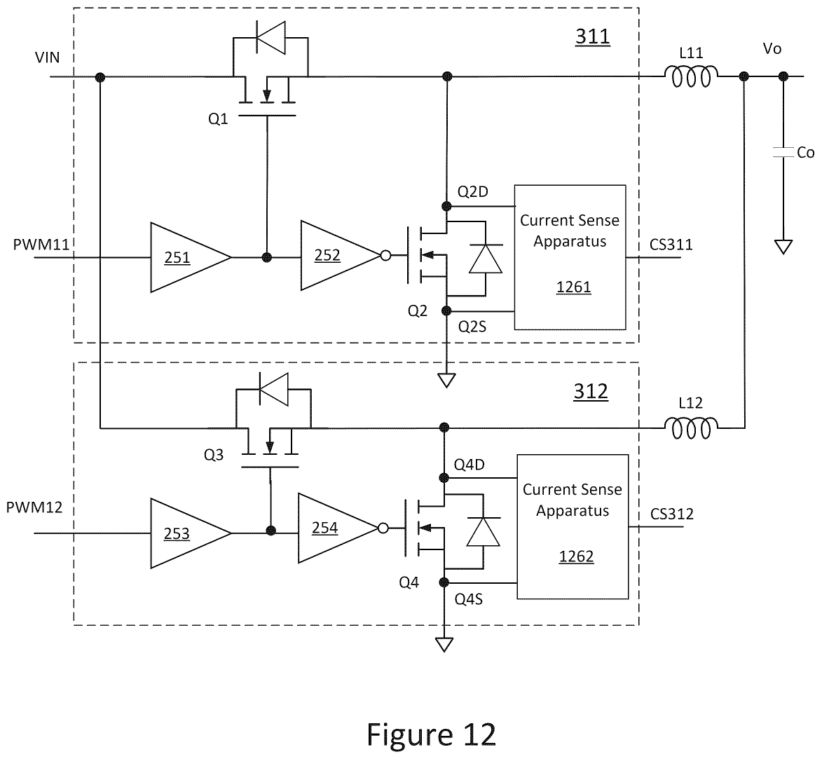

FIG. 12 illustrates a schematic diagram of a second implementation of the dual power stage shown in FIG. 3 in accordance with various embodiments of the present disclosure. The dual power stage comprises a first power stage 311 and a second power stage 312. As shown in FIG. 12, the first power stage 311 and the first inductor L11 form a first phase of the multiphase power conversion system. The second power stage 312 and the second inductor L12 form a second phase of the multiphase power conversion system. In operation, the first phase and the second phase are connected in parallel to supply power for a load coupled to the output voltage bus Vo of the multiphase power conversion system.

As shown in FIG. 12, the first phase of the multiphase power conversion system comprises a high-side switch Q1, a low-side switch Q2 and a first inductor L11. The high-side switch Q1 of the first phase and the first inductor L11 are connected in series between an input voltage bus VIN and the output voltage bus Vo. The low-side switch Q2 of the first phase is connected between a common node of the high-side switch Q1 of the first phase and the first inductor L11, and ground.

The second phase of the multiphase power conversion system comprises a high-side switch Q3, a low-side switch Q4 and the second inductor L12. The high-side switch Q3 of the second phase and the second inductor L12 are connected in series between the input voltage bus VIN and the output voltage bus Vo. The low-side switch Q4 of the second phase is connected between a common node of the high-side switch Q3 of the second phase and the second inductor L12, and ground. An output capacitor Co is connected between the output voltage bus Vo and ground.

The multiphase power conversion system further comprises a first current sense apparatus 1261 and a second current sense apparatus 1262. As shown in FIG. 12, a first input of the first current sense apparatus 1261 is connected to a drain Q2D of the low-side switch Q2. A second input of the first current sense apparatus 1261 is connected to a source Q2S of the low-side switch Q2. The first current sense apparatus 1261 is configured to sense the current flowing through the first inductor L11. As shown in FIG. 12, the first current sense apparatus 1261 is configured to generate a first current sense signal CS311. The structure and operating principle of the first current sense apparatus 1261 are similar to the structure and operating principle of the current sense apparatus 262 shown in FIG. 8, and hence are not discussed herein to avoid repetition.

As shown in FIG. 12, a first input of the second current sense apparatus 1262 is connected to a drain Q4D of the low-side switch Q4. A second input of the second current sense apparatus 1262 is connected to a source Q4S of the low-side switch Q4. The second current sense apparatus 1262 is configured to sense the current flowing through the second inductor L12. As shown in FIG. 12, the second current sense apparatus 1262 is configured to generate a second current sense signal CS312. The structure and operating principle of the second current sense apparatus 1262 are similar to structure and operating principle the current sense apparatus 262 shown in FIG. 8, and hence are not discussed herein to avoid repetition.

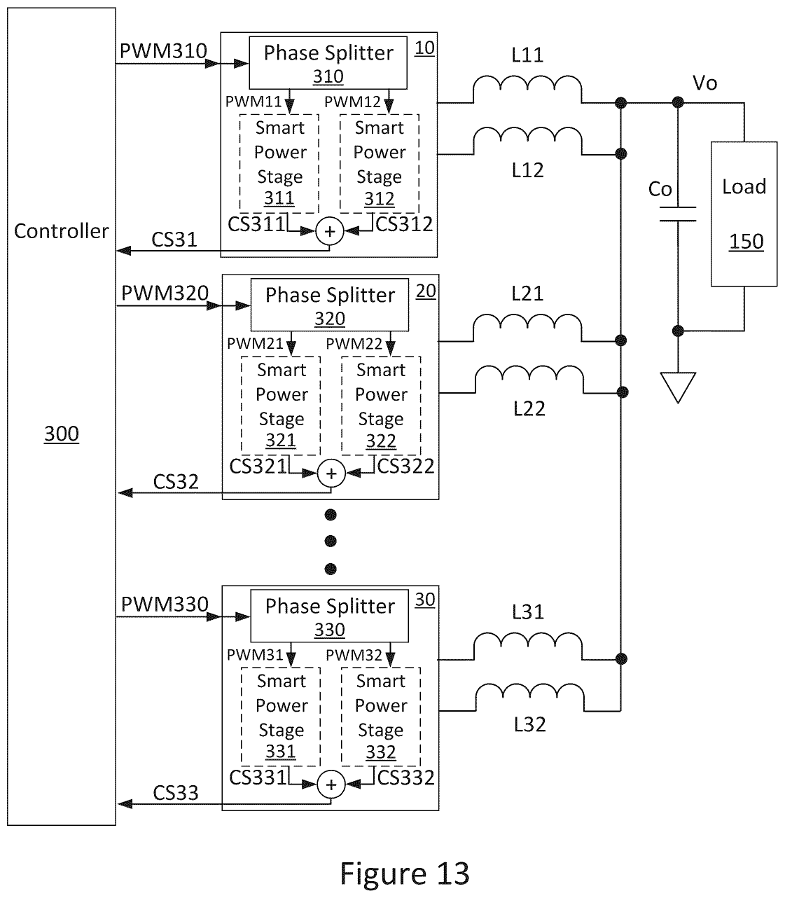

FIG. 13 illustrates a block diagram of a second implementation of the multiphase power conversion system having a reduced number of signal paths in accordance with various embodiments of the present disclosure. The system configuration shown in FIG. 13 is similar to that shown in FIG. 3 except that each of the plurality of dual smart power stages comprises a current summing module.

As shown in FIG. 13, the smart power stage 311 is configured to generate a first current sense signal CS311 fed into a first input of a current summing module of the first dual smart power stage 10. The smart power stage 312 is configured to generate a second current sense signal CS312 fed into a second input of the current summing module of the first dual smart power stage 10. The current summing module is configured to sum the first current sense signal CS311 and the second current sense signal CS312 together to obtain a mixed current sense signal CS31 fed into the multiphase controller 300.

As shown in FIG. 13, the smart power stage 321 is configured to generate a third current sense signal CS321 fed into a first input of the current summing module of the second dual smart power stage 20. The smart power stage 322 is configured to generate a fourth current sense signal CS322 fed into a second input of the current summing module of the second dual smart power stage 20. The current summing module is configured to sum the third current sense signal CS321 and the fourth current sense signal CS322 together to obtain a mixed current sense signal CS32 fed into the multiphase controller 300.

As shown in FIG. 13, the smart power stage 331 is configured to generate a fifth current sense signal CS331 fed into a first input of the current summing module of the third dual smart power stage 30. The smart power stage 332 is configured to generate a sixth current sense signal CS332 fed into a second input of the current summing module of the third dual smart power stage 30. The current summing module is configured to sum the fifth current sense signal CS331 and the sixth current sense signal CS332 together to obtain a mixed current sense signal CS33 fed into the multiphase controller 300.

As shown in FIG. 13, the number of PWM signal paths between the multiphase controller 300 and the dual smart power stages is equal to a number of the dual smart power stages. The number of current sense signal paths between the multiphase controller 300 and the dual smart power stages is equal to the number of the dual smart power stages. FIG. 13 shows for a multiphase power conversion system having N smart power stages, the number of PWM signal paths is equal to N/2. The number of current sense signal paths is equal to N/2. In total, there are 1×N signal paths in FIG. 13.

One advantageous feature of the system configuration shown in FIG. 13 is that the total number of signal paths has been reduced (from 2×N to 1×N). The reduced number of signal paths helps to minimize layout issues and ensures better performance.

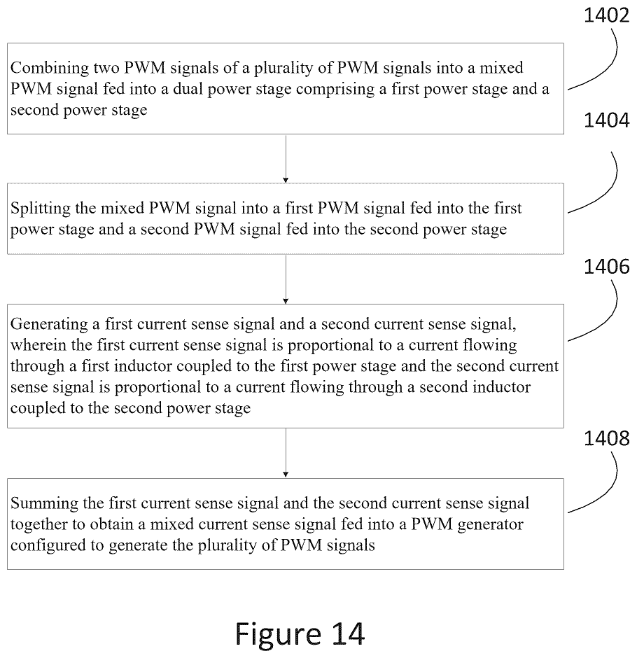

FIG. 14 illustrates a flow chart of a method for configuring the power conversion system shown in FIG. 3 in accordance with various embodiments of the present disclosure. This flowchart shown in FIG. 14 is merely an example, which should not unduly limit the scope of the claims. One of ordinary skill in the art would recognize many variations, alternatives, and modifications. For example, various steps illustrated in FIG. 14 may be added, removed, replaced, rearranged and repeated.

At step 1402, two PWM signals of a plurality of PWM signals are combined into a mixed PWM signal fed into a dual power stage comprising a first power stage and a second power stage.

At step 1404, the mixed PWM signal are split into a first PWM signal fed into the first power stage and a second PWM signal fed into the second power stage.

At step 1406, a first current sense signal and a second current sense signal are generated, wherein the first current sense signal is proportional to a current flowing through a first inductor coupled to the first power stage and the second current sense signal is proportional to a current flowing through a second inductor coupled to the second power stage.

At step 1408, the first current sense signal and the second current sense signal are summed together to obtain a mixed current sense signal fed into a PWM generator configured to generate the plurality of PWM signals.

In some embodiments, the first power stage comprises a high-side switch and a low-side switch connected in series between an input voltage bus and ground, and wherein the first inductor is connected to a common node of the high-side switch and the low-side switch, and a current sense apparatus having two inputs coupled to two terminals of the low-side switch, respectively, and an output configured to generate the first current sense signal.

The method further comprises generating, by a PWM off time current sense circuit, a PWM off time current signal proportional to a current flowing through the first inductor when the high-side switch is turned off and the low-side switch is turned on, constructing, by a PWM on time current rebuild circuit, an artificial inductor current signal using a voltage-controlled current source to charge a rebuild capacitor when the high-side switch is turned on, and adjusting, by a feedback loop, a current flowing through the voltage-controlled current source so as to force a saved voltage of the artificial inductor current signal to be equal to a saved voltage of the PWM off time current signal.

The method further comprises upon detecting that the saved voltage of the artificial inductor current signal is higher than the saved voltage of the PWM off time current signal, adjusting the voltage-controlled current source to decrease the saved voltage of the artificial inductor current signal until the saved voltage of the artificial inductor current signal is equal to the saved voltage of the PWM off time current signal, and upon detecting that the saved voltage of the artificial inductor current signal is lower than the saved voltage of the PWM off time current signal, adjusting the voltage-controlled current source to increase the saved voltage of the artificial inductor current signal until the saved voltage of the artificial inductor current signal is equal to the saved voltage of the PWM off time current signal.

In some embodiments, the PWM off time current sense circuit comprises a low-side switch current sense unit, a first switch, a second switch, a third switch, an inverter, a delay unit, and wherein the low-side switch current sense unit has a first input coupled to the common node of the high-side switch and the low-side switch, a second input connected to ground, and an output configured to generate the PWM off time current signal, the first switch is connected between the common node of the high-side switch and the low-side switch, and the first input of the low-side switch current sense unit, the second switch is connected between the first input and the second input of the low-side switch current sense unit, the third switch is connected to the output of the low-side switch current sense unit, wherein the PWM off time current signal is fed into the rebuild capacitor through the third switch, a low-side current sense control signal is configured to control the first switch directly and control the second switch through the inverter, and the low-side current sense control signal is configured to control the third switch through the delay unit. The PWM on time current rebuild circuit comprises the voltage-controlled current source, the rebuild capacitor and a fourth switch, and wherein the voltage-controlled current source is connected to the rebuild capacitor through the fourth switch, and the fourth switch is controlled by an enable signal, and wherein the fourth switch is configured to be turned on when the high-side switch is turned on. The feedback loop comprises a track-and-hold circuit, a transconductance amplifier and a compensation capacitor, and wherein an input of the track-and-hold circuit is connected to both the PWM off time current sense circuit and the PWM on time current rebuild circuit, two inputs of the transconductance amplifier are connected to two outputs of the track-and-hold circuit, respectively, and the compensation capacitor is connected to an output of the transconductance amplifier, and wherein the track-and-hold circuit comprises a fifth switch, a first hold capacitor, a sixth switch and a second hold capacitor, and wherein the fifth switch and the first hold capacitor are connected in series between the input of the track-and-hold circuit and ground, and wherein a common node of the fifth switch and the first hold capacitor is connected to a first input of the transconductance amplifier, and the sixth switch and the second hold capacitor are connected in series between the input of the track-and-hold circuit and ground, and wherein a common node of the sixth switch and the second hold capacitor is connected to a second input of the transconductance amplifier.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. A power conversion system comprising:
a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal; and
a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage.

2. The power conversion system of claim 1, wherein:
the first power stage is configured to generate a first current sense signal, and wherein the first current sense signal is proportional to a current flowing through a first inductor coupled to the first power stage; and
the second power stage is configured to generate a second current sense signal, and wherein the second current sense signal is proportional to a current flowing through a second inductor coupled to the second power stage.

3. The power conversion system of claim 2, wherein:
the first power stage and the first inductor form a first phase of the power conversion system, and wherein the first power stage comprises:
a high-side switch of the first power stage and a capacitor connected in series between an input voltage bus and the first inductor;
a low-side switch of the first power stage connected between a common node of the capacitor and the first inductor, and ground; and
a first current sense apparatus having two inputs coupled to two terminals of the low-side switch of the first power stage, respectively, and an output configured to generate the first current sense signal; and
the second power stage and the second inductor form a second phase of the power conversion system, and wherein the second power stage comprises:
a high-side switch of the second power stage connected between a common node of the high-side switch of the first power stage and the capacitor, and the second inductor;
a low-side switch of the second power stage connected between a common node of the high-side switch of the second power stage and the second inductor, and ground; and
a second current sense apparatus having two inputs coupled to two terminals of the low-side switch of the second power stage, respectively, and an output configured to generate the second current sense signal.

4. The power conversion system of claim 3, wherein:
the first current sense apparatus comprises a first phase PWM off time current sense circuit, a first phase PWM on and off time current rebuild circuit and a first phase feedback loop; and
the second current sense apparatus comprises a second phase PWM off time current sense circuit, a second phase PWM on time current rebuild circuit and a second phase feedback loop.

5. The power conversion system of claim 4, wherein:
the first phase PWM off time current sense circuit is configured to generate a first portion and a third portion of a first phase PWM off time current signal proportional to a current flowing through the first inductor in the first phase when the high-side switch of the second phase is turned off, and the low-side switch of the first phase of the power converter is turned on;
the first phase PWM on and off time current rebuild circuit is configured to construct a second portion of the first phase PWM off time current signal using a second voltage-controlled current source to discharge a first rebuild capacitor when the high-side switch of the second phase is turned on, and construct an artificial first phase inductor current signal using a first voltage-controlled current source to charge the first rebuild capacitor when the high-side switch of the first phase is turned on; and
the first phase feedback loop is configured to adjust a current flowing through the second voltage-controlled current source so as to force a saved voltage of the second portion of the first phase PWM off time current signal to be equal to a saved voltage of the third portion of the first phase PWM off time current signal, and adjust a current flowing through the first voltage-controlled current source so as to force a saved voltage of the artificial first phase inductor current signal to be equal to a saved voltage of the first portion of the first phase PWM off time current signal.

6. The power conversion system of claim 4, wherein:
the second phase PWM off time current sense circuit is configured to generate a second phase PWM off time current signal proportional to a current flowing through the second inductor in the second phase when the high-side switch of the second phase is turned off and the low-side switch of the second phase is turned on;
the second phase PWM on time current rebuild circuit is configured to construct an artificial second phase inductor current signal using a second phase voltage-controlled current source to charge a second rebuild capacitor when the high-side switch of the second phase is turned on; and
the second phase feedback loop is configured to adjust a current flowing through the second phase voltage-controlled current source so as to force a saved voltage of the artificial second phase inductor current signal to be equal to a saved voltage of the second phase PWM off time current signal.

7. The power conversion system of claim 4, further comprising:
a current summing module, wherein:
the first current sense signal is fed into a first input of the current summing module;
the second current sense signal is fed into a second input of the current summing module; and
the current summing module is configured to sum the first current sense signal and the second current sense signal together to obtain a mixed current sense signal fed into the PWM generator.

8. The power conversion system of claim 7, wherein:
as a result of having the current summing module, a number of current sense signal paths in the power conversion system is equal to a number of the plurality of dual power stages in the power conversion system.

9. The power conversion system of claim 1, wherein:
a phase shift between the two PWM signals is equal to 180 degrees.

10. The power conversion system of claim 2, wherein:
the first power stage comprises:
a high-side switch of the first power stage connected between an input voltage bus and the first inductor;
a low-side switch of the first power stage connected between a common node of the high-side switch of the first power stage and the first inductor, and ground; and
a first current sense apparatus having two inputs coupled to two terminals of the low-side switch of the first power stage, respectively, and an output configured to generate the first current sense signal; and
the second power stage comprises:
a high-side switch of the second power stage connected between the input voltage bus and the second inductor;
a low-side switch of the second power stage connected between a common node of the high-side switch of the second power stage and the second inductor, and ground; and
a second current sense apparatus having two inputs coupled to two terminals of the low-side switch of the second power stage, respectively, and an output configured to generate the second current sense signal.

11. The power conversion system of claim 1, wherein:
the phase splitter comprises a latch, a first AND gate and a second AND gate, and wherein:
a data input of the latch is connected to an inverted output of the latch;
a clock input of the latch is configured to receive the mixed PWM signal;
a first input of the first AND gate is configured to receive the mixed PWM signal;
a second input of the first AND gate is connected to an output of the latch;
an output of the first AND gate is configured to generate the first PWM signal;
a first input of the second AND gate is connected to the inverted output of the latch;
a second input of the second AND gate is configured to receive the mixed PWM signal; and
an output of the second AND gate is configured to generate the second PWM signal.

12. A method comprising:
combining two PWM signals of a plurality of PWM signals into a mixed PWM signal fed into a dual power stage comprising a first power stage and a second power stage;
splitting the mixed PWM signal into a first PWM signal fed into the first power stage and a second PWM signal fed into the second power stage;
generating a first current sense signal and a second current sense signal, wherein the first current sense signal is proportional to a current flowing through a first inductor coupled to the first power stage and the second current sense signal is proportional to a current flowing through a second inductor coupled to the second power stage; and
summing the first current sense signal and the second current sense signal together to obtain a mixed current sense signal fed into a PWM generator configured to generate the plurality of PWM signals.

13. The method of claim 12, wherein the first power stage comprises:
a high-side switch and a low-side switch connected in series between an input voltage bus and ground, and wherein the first inductor is connected to a common node of the high-side switch and the low-side switch; and
a current sense apparatus having two inputs coupled to two terminals of the low-side switch, respectively, and an output configured to generate the first current sense signal.

14. The method of claim 13, further comprising:
generating, by a PWM off time current sense circuit, a PWM off time current signal proportional to a current flowing through the first inductor when the high-side switch is turned off and the low-side switch is turned on;
constructing, by a PWM on time current rebuild circuit, an artificial inductor current signal using a voltage-controlled current source to charge a rebuild capacitor when the high-side switch is turned on; and
adjusting, by a feedback loop, a current flowing through the voltage-controlled current source so as to force a saved voltage of the artificial inductor current signal to be equal to a saved voltage of the PWM off time current signal.

15. The method of claim 14, further comprising:
upon detecting that the saved voltage of the artificial inductor current signal is higher than the saved voltage of the PWM off time current signal, adjusting the voltage-controlled current source to decrease the saved voltage of the artificial inductor current signal until the saved voltage of the artificial inductor current signal is equal to the saved voltage of the PWM off time current signal; and
upon detecting that the saved voltage of the artificial inductor current signal is lower than the saved voltage of the PWM off time current signal, adjusting the voltage-controlled current source to increase the saved voltage of the artificial inductor current signal until the saved voltage of the artificial inductor current signal is equal to the saved voltage of the PWM off time current signal.

16. The method of claim 14, wherein:
the PWM off time current sense circuit comprises a low-side switch current sense unit, a first switch, a second switch, a third switch, an inverter, a delay unit, and wherein:
the low-side switch current sense unit has a first input coupled to the common node of the high-side switch and the low-side switch, a second input connected to ground, and an output configured to generate the PWM off time current signal;
the first switch is connected between the common node of the high-side switch and the low-side switch, and the first input of the low-side switch current sense unit;
the second switch is connected between the first input and the second input of the low-side switch current sense unit;
the third switch is connected to the output of the low-side switch current sense unit, wherein the PWM off time current signal is fed into the rebuild capacitor through the third switch;
a low-side current sense control signal is configured to control the first switch directly and control the second switch through the inverter; and
the low-side current sense control signal is configured to control the third switch through the delay unit;
the PWM on time current rebuild circuit comprises the voltage-controlled current source, the rebuild capacitor and a fourth switch, and wherein:
the voltage-controlled current source is connected to the rebuild capacitor through the fourth switch; and
the fourth switch is controlled by an enable signal, and wherein the fourth switch is configured to be turned on when the high-side switch is turned on; and
the feedback loop comprises a track-and-hold circuit, a transconductance amplifier and a compensation capacitor, and wherein:
an input of the track-and-hold circuit is connected to both the PWM off time current sense circuit and the PWM on time current rebuild circuit;
two inputs of the transconductance amplifier are connected to two outputs of the track-and-hold circuit, respectively; and
the compensation capacitor is connected to an output of the transconductance amplifier, and wherein the track-and-hold circuit comprises a fifth switch, a first hold capacitor, a sixth switch and a second hold capacitor, and wherein:
the fifth switch and the first hold capacitor are connected in series between the input of the track-and-hold circuit and ground, and wherein a common node of the fifth switch and the first hold capacitor is connected to a first input of the transconductance amplifier; and
the sixth switch and the second hold capacitor are connected in series between the input of the track-and-hold circuit and ground, and wherein a common node of the sixth switch and the second hold capacitor is connected to a second input of the transconductance amplifier.

17. A system comprising:
a multiphase controller comprising a PWM generator and a plurality of signal summing modules, wherein the PWM generator is configured to generate a plurality of PWM signals, and each signal summing module is configured to receive two PWM signals and combine the two PWM signals into a mixed PWM signal;
a plurality of dual power stages, each of which comprises a phase splitter, a first power stage and a second power stage, wherein the phase splitter is configured to receive the mixed PWM signal, and split the mixed PWM signal into a first PWM signal fed into the first power stage and a second PWM signal fed into the second power stage;
a first inductor coupled between the first power stage and an output of the system; and
a second inductor coupled between the second power stage and the output of the system.

18. The system of claim 17, wherein:
the first power stage comprises:
a first high-side switch and a first low-side switch connected in series between an input voltage bus and ground, and wherein the first inductor is connected between a common node of the first high-side switch and the first low-side switch, and the output of the system; and
a first current sense apparatus having two inputs coupled to two terminals of the first low-side switch, respectively, and an output configured to generate the first current sense signal; and
the second power stage comprises:
a second high-side switch and a second low-side switch connected in series between the input voltage bus and ground, and wherein the second inductor is connected between a common node of the second high-side switch and the second low-side switch, and the output of the system; and
a second current sense apparatus having two inputs coupled to two terminals of the second low-side switch, respectively, and an output configured to generate the second current sense signal.

19. The system of claim 17, further comprising:
a current summing module, wherein:
the first current sense signal is fed into a first input of the current summing module;
the second current sense signal is fed into a second input of the current summing module; and
the current summing module is configured to sum the first current sense signal and the second current sense signal together to obtain a mixed current sense signal fed into the PWM generator, and wherein as a result of having the current summing module, a number of current sense signal paths in the system is equal to a number of the plurality of dual power stages in the system.

20. The system of claim 17, wherein:
a phase shift between the two PWM signals is equal to 180 degrees; and
the phase splitter comprises a latch, a first AND gate and a second AND gate, and wherein:
a data input of the latch is connected to an inverted output of the latch;
a clock input of the latch is configured to receive the mixed PWM signal;
a first input of the first AND gate is configured to receive the mixed PWM signal;
a second input of the first AND gate is connected to an output of the latch;
an output of the first AND gate is configured to generate the first PWM signal;
a first input of the second AND gate is connected to the inverted output of the latch;
a second input of the second AND gate is configured to receive the mixed PWM signal; and
an output of the second AND gate is configured to generate the second PWM signal.
